(19) United States
(12) Patent Application Publication
(10) Pub. No.: US 2005/0036548 A1
(43) Pub. Date: Feb. 17, 2005

(54) Method and apparatus for selection of bit budget adjustment in dual pass encoding

(76) Inventors: Yong He, San Diego, CA (US); Siu Wai Wu, San Diego, CA (US)

Correspondence Address: Kin-Wah Tong;Moser, Patterson & Sheridan, LLP, Suite 100, 595 Shrewsbury Avenue, Shrewsbury, NJ, 07702, US

(21) Appl. No.: 10/888,267

(22) Filed: Jul. 9, 2004

Related U.S. Application Data
(60) Provisional application No. 60/494,514, filed on Aug. 12, 2003.

(51) Int. Cl. H04N 7/12

(52) U.S. Cl. 375/240.12; 375/240.03

(57) ABSTRACT

The present invention discloses a system and method for adaptive adjustment of bit budget based on the content of the input image sequence. In one embodiment, two encoders are employed in a dual pass encoding system. A first encoder receives the input image sequence and encodes each frame of the image sequence using a standard or any predefined encoding algorithms. Specifically, by encoding the image sequence using the first encoder, the first encoder is able to assess the complexity of each picture in the image sequence, e.g., by measuring the number of bits needed to encode each picture. This complexity information serves as look-ahead information for a second encoder.

This application claims the benefit of U.S. Provisional Application No. 60/494,514 filed on Aug. 12, 2003, which is herein incorporated by reference.

### BACKGROUND OF THE INVENTION

1. Field of the Invention

Embodiments of the present invention generally relate to an encoding system. More specifically, the present invention relates to a dual pass encoding system where bit budget can be adaptively adjusted.

2. Description of the Related Art

Demands for lower bit-rates and higher video quality requires efficient use of bandwidth. To achieve these goals, the Moving Picture Experts Group (MPEG) created the Moving Picture Experts Group (MPEG) created the ISO/IEC international Standards 11172 (1991) (generally referred to as MPEG-1 format) and 13818 (1995) (generally referred to as MPEG-2 format), which are incorporated herein in their entirety by reference. One goal of these standards is to establish a standard coding/decoding strategy with sufficient flexibility to accommodate a plurality of different applications and services such as desktop video publishing, video telephone, video conferencing, digital storage media and television broadcast.

Although the MPEG standards specify a general coding methodology and syntax for generating a MPEG compliant bitstream, many variations are permitted in the values assigned to many of the parameters, thereby supporting a broad range of applications and interoperability. In effect, MPEG does not define a specific algorithm needed to produce a valid bitstream. Furthermore, MPEG encoder designers are accorded great flexibility in developing and implementing their own MPEG-specific algorithms in areas such as image pre-processing, motion estimation, coding mode decisions, scalability, rate control and scan mode decisions. However, a common goal of MPEG encoder designers is to minimize subjective distortion for a prescribed bit rate and operating delay constraint.

In the area of rate control, MPEG does not define a specific algorithm for controlling the bit rate of an encoder. It is the task of the encoder designer to devise a rate control process for controlling the bit rate such that the decoder input buffer neither overflows nor underflows. A fixed-rate channel is assumed to carry bits at a constant rate to an input buffer within the decoder. At regular intervals determined by the picture rate, the decoder instantaneously removes all the bits for the next picture from its input buffer. If there are too few bits in the input buffer, i.e., all the bits for the next picture have not been received, then the input buffer underflows resulting in an error. Similarly, if there are too many bits in the input buffer, i.e., the capacity of the input buffer is exceeded between picture starts, then the input buffer overflows resulting in an overflow error. Thus, it is the task of the encoder to monitor the number of bits generated by the encoder, thereby preventing the overflow and underflow conditions.

Currently, one way of controlling the bit rate is to alter the quantization process, which will affect the distortion of the input video image. By altering the quantizer scale (step size), the bit rate can be changed and controlled. To illustrate, if the buffer is heading toward overflow, the quantizer scale should be increased. This action causes the quantization process to reduce additional Discrete Cosine Transform (DCT) coefficients to the value “zero”, thereby reducing the number of bits necessary to code a macroblock. This, in effect, reduces the bit rate and should resolve a potential overflow condition. However, if this action is not sufficient to prevent an impending overflow then, as a last resort, the encoder may discard high frequency DCT coefficients and only transmit low frequency DCT coefficients. Although this drastic measure will not compromise the validity of the coded bitstream, it will produce visible artifacts in the decoded video image.

Conversely, if the buffer is heading toward underflow, the quantizer scale should be decreased. This action increases the number of non-zero quantized DCT coefficients, thereby increasing the number of bits necessary to code a macroblock. Thus, the increased bit rate should resolve a potential underflow condition. However, if this action is not sufficient, then the encoder may insert stuffing bits into the bitstream, or add leading zeros to the start codes.

Although changing the quantizer scale is an effective method of implementing the rate control of an encoder, it has been shown that a poor rate control process will actually degrade the visual quality of the video image, i.e., failing to alter the quantizer scale in an efficient manner such that it is necessary to drastically alter the quantizer scale toward the end of a picture to avoid overflow and underflow conditions. Since altering the quantizer scale affects both image quality and compression efficiency, it is important for a rate control process to control the bit rate without sacrificing image quality.

Thus, there is a need in the art for an encoding system and method that can dynamically adjust the bit budget while maintaining image quality and compression efficiency.

### SUMMARY OF THE INVENTION

In one embodiment, the present invention discloses a system and method for adaptive adjustment of bit budget based on the content of the input image sequence. Namely, an encoder is able to dynamically adjust the bit budget for each picture in an image sequence, thereby effecting proper usage of the available transmission bandwidth and improving the picture quality.

In one embodiment, two encoders are employed in a dual pass encoding system. A first encoder receives the input image sequence and encodes each frame of the image sequence using a standard or any predefined encoding algorithms. Specifically, by encoding the image sequence using the first encoder, the first encoder is able to assess the complexity of each picture in the image sequence, e.g., by measuring the number of bits needed to encode each picture. This complexity information serves as look-ahead information for a compliant encoder.

Namely, the complexity information is provided to a second encoder that will be able to adaptively adjust the bit budget for each picture to actually encode the input image sequence. In one embodiment, the complexity information can be stored for a number of pictures or frames, thereby allowing the second encoder to foresee upcoming events that may significantly impact the rate control process, e.g., scene changes, new GOP, very complex pictures, still pictures without significant motions, and the like.

By using the complexity information, the second pass encoder is able to achieve better usage of the available transmission bandwidth, thereby improving the picture quality. For example, the present invention can be employed to handle video break up and to reduce pulsing noise in low bit rate implementation.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a dual pass encoding system of the present invention;

FIG. 2 illustrates a motion compensated encoder of the present invention;

FIG. 3 illustrates a method for adjusting the bit budget of the present invention;

FIG. 4 illustrates a second method for adjusting the bit budget of the present invention; and

FIG. 5 illustrates the present invention implemented using a general purpose computer.

To facilitate understanding, identical reference numerals have been used, wherever possible, to designate identical elements that are common to the figures.

### DETAILED DESCRIPTION OF THE PREFERRED EMBODIMENT

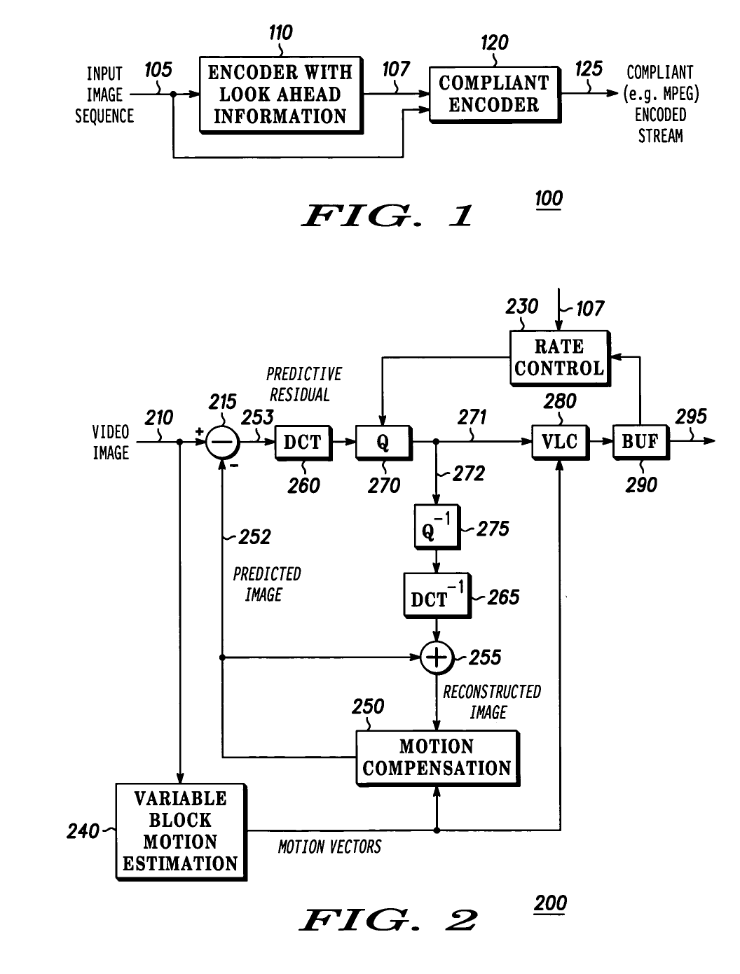

FIG. 1 illustrates a dual pass encoding system 100 of the present invention. The dual pass encoding system 100 comprises a first encoder 110 and a second encoder 120. In operation, the first encoder 110 implements a predefined or standard encoding method where each picture within the input image sequence on path 105 is encoded using a predefined encoding method. The resulting complexity information (e.g., the number of encoding bits used for each picture) is then provided to the second encoder 120. In turn, the second encoder 120 is now provided with the complexity information to allow it to adjust the bit budget for each picture in the image sequence to actually encode the input image sequence on path 105 into a compliant (e.g., MPEG-compliant) encoded stream on path 125.

It should be noted that the first encoder 110 need not be a compliant encoder, e.g., an MPEG encoder. The reason is that the image sequence is actually not being encoded into the final compliant encoded stream by the first encoder. The main purpose of the first encoder is to apply an encoding method to each image within the input image sequence, so that complexity measure for each picture can be deduced, e.g., on path 107. Certainly, the encoding method of the first encoder can be similar or even identical to the encoding method employed in the second encoder. However, since it is only necessary to deduce the relative complexity of each picture relative to other pictures in the input image sequence, a less complex encoding method can be deployed in the first decoder.

In turn, the complexity information on path 107 can be effectively exploited by the second encoder to properly adjust the bit budget to actually encode the image sequence. Thus, the first encoder can be a non-compliant encoder or a compliant encoder, whereas the second encoder is a compliant encoder.

It should be noted that although the present invention is described within the context of MPEG-2, the present invention is not so limited. Namely, the compliant encoder can be an MPEG-2 compliant encoder or an encoder that is compliant to any other compression standards, e.g., MPEG-4, H.261, H.263 and so on. In other words, the present invention can be applied to any other compression standards that allow a flexible rate control implementation.

FIG. 2 depicts a block diagram of an exemplary motion compensated encoder 200 of the present invention, e.g., the compliant encoder 120 of FIG. 1. In one embodiment of the present invention, the apparatus 200 is an encoder or a portion of a more complex variable block-based motion compensation coding system. The apparatus 200 comprises a variable block motion estimation module 240, a motion compensation module 250, a rate control module 230, a discrete cosine transform (DCT) module 260, a quantization (Q) module 270, a variable length coding (VLC) module 280, a buffer (BUF) 290, an inverse quantization (Q⁻¹) module 275, an inverse DCT (DCT⁻¹) transform module 265, a subtractor 215 and a summer 255. Although the apparatus 200 comprises a plurality of modules, those skilled in the art will realize that the functions performed by the various modules are not required to be isolated into separate modules as shown in FIG. 2. For example, the set of modules comprising the motion compensation module 250, inverse quantization module 275 and inverse DCT module 265 is generally known as an “embedded decoder”.

FIG. 2 illustrates an input video image (image sequence) on path 210 which is digitized and represented as a luminance and two color difference signals (Y, Cᵣ, C_{b}) in accordance with the MPEG standards. These signals are further divided into a plurality of layers (sequence, group of pictures, picture, slice and blocks) such that each picture (frame) is represented by a plurality of blocks having different sizes. The division of a picture into block units improves the ability to discern changes between two successive pictures and improves image compression through the elimination of low amplitude transformed coefficients (discussed below). The digitized signal may optionally undergo preprocessing such as format conversion for selecting an appropriate window, resolution and input format.

The input video image on path 210 is received into variable block motion estimation module 240 for estimating motion vectors. The motion vectors from the variable block motion estimation module 240 are received by the motion compensation module 250 for improving the efficiency of the prediction of sample values. Motion compensation involves a prediction that uses motion vectors to provide offsets into the past and/or future reference frames containing previously decoded sample values that are used to form the prediction error. Namely, the motion compensation module 250 uses the previously decoded frame and the motion vectors to construct an estimate of the current frame.

Furthermore, prior to performing motion compensation prediction for a given block, a coding mode must be selected. In the area of coding mode decision, MPEG provides a plurality of different coding modes. Generally, these coding modes are grouped into two broad classifications, inter mode coding and intra mode coding. Intra mode coding involves the coding of a block or picture that uses information only from that block or picture. Conversely, inter mode coding involves the coding of a block or picture that uses information both from itself and from blocks and pictures occurring at different times. Specifically, MPEG-2 provides coding modes which include intra mode, no motion compensation mode (No MC), frame/field/dual-prime motion compensation inter mode, forward/backward/average inter mode and field/frame DCT mode. The proper selection of a coding mode for each block will improve coding performance. Again, various methods are currently available to an encoder designer for implementing coding mode decision.

Once a coding mode is selected, motion compensation module 250 generates a motion compensated prediction (predicted image) on path 252 of the contents of the block based on past and/or future reference pictures. This motion compensated prediction on path 252 is subtracted via subtractor 215 from the video image on path 210 in the current block to form an error signal or predictive residual signal on path 253. The formation of the predictive residual signal effectively removes redundant information in the input video image. Namely, instead of transmitting the actual video image via a transmission channel, only the information necessary to generate the predictions of the video image and the errors of these predictions are transmitted, thereby significantly reducing the amount of data needed to be transmitted. To further reduce the bit rate, predictive residual signal on path 253 is passed to the DCT module 260 for encoding.

The DCT module 260 then applies a forward discrete cosine transform process to each block of the predictive residual signal to produce a set of eight (8) by eight (8) blocks of DCT coefficients. The number of 8×8 blocks of DCT coefficients will depend upon the size of each block. The discrete cosine transform is an invertible, discrete orthogonal transformation where the DCT coefficients represent the amplitudes of a set of cosine basis functions. One advantage of the discrete cosine transform is that the DCT coefficients are uncorrelated. This decorrelation of the DCT coefficients is important for compression, because each coefficient can be treated independently without the loss of compression efficiency. Furthermore, the DCT basis function or subband decomposition permits effective use of psychovisual criteria which is important for the next step of quantization.

The resulting 8×8 block of DCT coefficients is received by quantization module 270 where the DCT coefficients are quantized. The process of quantization reduces the accuracy with which the DCT coefficients are represented by dividing the DCT coefficients by a set of quantization values with appropriate rounding to form integer values. The quantization values can be set individually for each DCT coefficient, using criteria based on the visibility of the basis functions (known as visually weighted quantization). Namely, the quantization value corresponds to the threshold for visibility of a given basis function, i.e., the coefficient amplitude that is just detectable by the human eye. By quantizing the DCT coefficients with this value, many of the DCT coefficients are converted to the value “zero”, thereby improving image compression efficiency. The process of quantization is a key operation and is an important tool to achieve visual quality and to control the encoder to match its output to a given bit rate (rate control). Since a different quantization value can be applied to each DCT coefficient, a “quantization matrix” is generally established as a reference table, e.g., a luminance quantization table or a chrominance quantization table. Thus, the encoder chooses a quantization matrix that determines how each frequency coefficient in the transformed block is quantized.

Next, the resulting 8×8 block of quantized DCT coefficients is received by variable length coding module 280 via signal connection 271, where the two-dimensional block of quantized coefficients is scanned using a particular scanning mode, e.g., a “zig-zag” order to convert it into a one-dimensional string of quantized DCT coefficients. For example, the zig-zag scanning order is an approximate sequential ordering of the DCT coefficients from the lowest spatial frequency to the highest. Since quantization generally reduces DCT coefficients of high spatial frequencies to zero, the one-dimensional string of quantized DCT coefficients is typically represented by several integers followed by a string of zeros.

Variable length coding (VLC) module 280 then encodes the string of quantized DCT coefficients and all side-information for the block such as block type and motion vectors. The VLC module 280 utilizes variable length coding and run-length coding to efficiently improve coding efficiency. Variable length coding is a reversible coding process where shorter code-words are assigned to frequent events and longer code-words are assigned to less frequent events, while run-length coding increases coding efficiency by encoding a run of symbols with a single symbol. These coding schemes are well known in the art and are often referred to as Huffman coding when integer-length code words are used. Thus, the VLC module 280 performs the final step of converting the input video image into a valid data stream.

The data stream is received into a “First In-First Out” (FIFO) buffer 290. A consequence of using different picture types and variable length coding is that the overall bit rate into the FIFO is variable. Namely, the number of bits used to code each frame can be different. In applications that involve a fixed-rate channel, a FIFO buffer is used to match the encoder output to the channel for smoothing the bit rate. Thus, the output signal of FIFO buffer 290 is a compressed representation of the input video image 210, where it is sent to a storage medium or telecommunication channel on path 295.

The rate control module 230 serves to monitor and adjust the bit rate of the data stream entering the FIFO buffer 290 for preventing overflow and underflow on the decoder side (within a receiver or target storage device, not shown) after transmission of the data stream. A fixed-rate channel is assumed to put bits at a constant rate into an input buffer within the decoder. At regular intervals determined by the picture rate, the decoder instantaneously removes all the bits for the next picture from its input buffer. If there are too few bits in the input buffer, i.e., all the bits for the next picture have not been received, then the input buffer underflows resulting in an error. Similarly, if there are too many bits in the input buffer, i.e., the capacity of the input buffer is exceeded between picture starts, then the input buffer overflows resulting in an overflow error. Thus, it is the task of the rate control module 230 to monitor the status of buffer 290 to control the number of bits generated by the encoder, thereby preventing the overflow and underflow conditions. Rate control algorithms play an important role in affecting image quality and compression efficiency.

In one embodiment, the proper adjustment of the bit budget for each picture of an input image sequence in the rate control module 230 is determined from information received on path 107. Namely, the complexity for each encoded image can be easily determined based upon the result supplied by the first pass encoder 110. To illustrate, the second pass encoder 120 may compare the complexity (bits used) for encoding recent pictures and the fullness of the buffer 290 before the start of encoding of the next picture. This forward looking capability due to the information received on path 107 can be effectively exploited by the second encoder to properly adjust the bit budget to actually encode the image sequence.

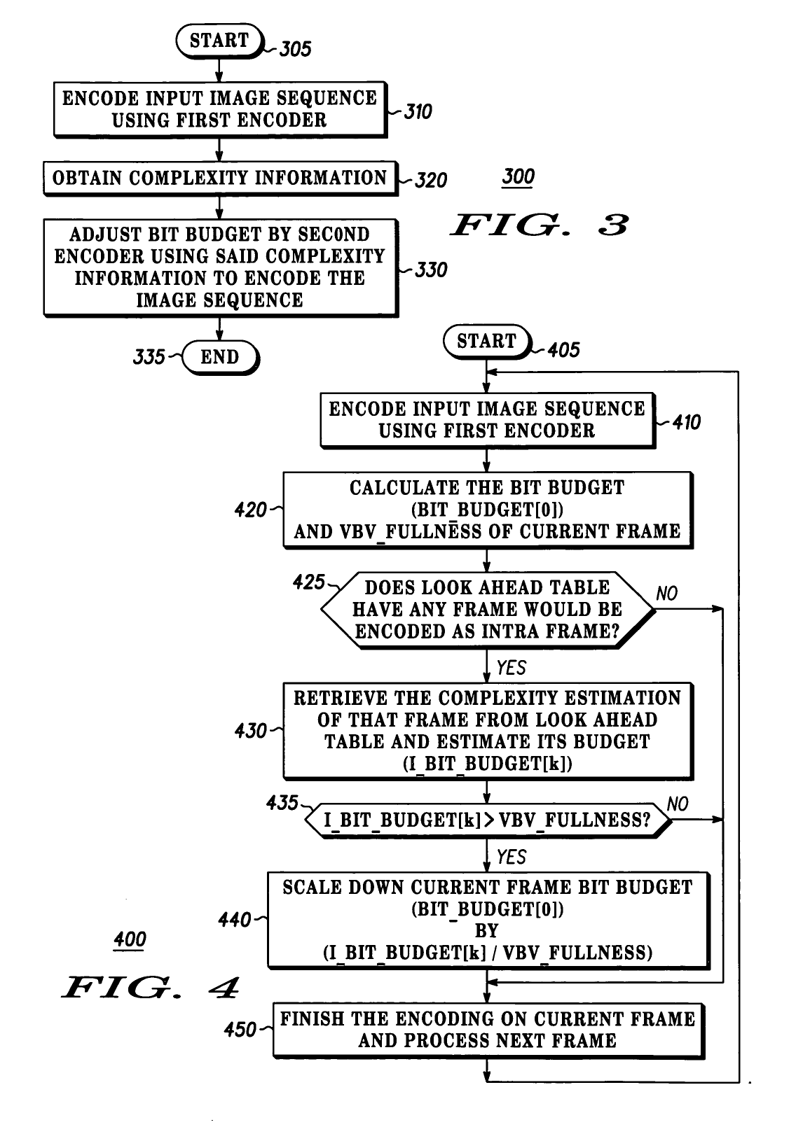

FIG. 3 illustrates a method 300 for adjusting the bit budget of the present invention. Specifically, in a dual pass encoding rate control method, the second pass encoder takes advantage of the look ahead information from the first pass encoder and determine the picture coding type and/or required bit budget.

Method 300 starts in step 305 and proceeds to step 310. In step 310, method 300 encodes each picture of an input image sequence using a standard or predefined encoding method.

In step 320, after encoding each picture, method 300 is able to deduce the complexity of each picture. For example, the number of bits needed to encode the picture is indicative of the picture's complexity.

In step 330, method 300 adjusts the bit budget of each picture based upon the complexity information received from the first encoder before encoding the picture in a second encoder. For example, the bit rate control method calculates the initial bit budget of the frame depending on the picture coding type that is decided:
For I frame: I_bit_budget=(bit_rate)/(Ki+(Kp*Cp/Ci)+(Kb*Cb/Ci));
For P frame: P_bit_budget=(bit_rate)/(Kp+(Ki*Ci/Cp)+(Kb*Cb/Cp));
For B frame: B_Bit_budget=(bit_rate)/(Kb+(Ki*Ci/Cb)+(Kp*Cp/Cb));
   where Ki, Kp and Kb represent the number of I, P and B frames in one group of pictures (GOP), where Ci, Cp and Cb represent the complexity coefficient of relative I, P and B frames:
Ci=Ri*Qi*Pass1Ci/prevPass1Ci;
Cp=Rp*Qp*Pass1Cp/prevPass1Cp;
Cb=Rb*Qb*Pass1Cb/prevpass1Cb;
   where Ri represents the encoding bits of the last I frame on the second pass encoder, Qi represents the average quantization level of the last I frame on the second pass encoder, Pass1Ci is the first pass encoder estimated I complexity of current I frame on the second pass encoder, and prevPass1Ci is the first pass encoder estimated I complexity of last I frame of the second pass encoder;
   where Rp represents the encoding bits of the last P frame on the second pass encoder, Qp represents the average quantization level of the last P frame on the second pass encoder, Pass1Cp is the first pass encoder estimated P complexity of the current P frame on the second pass encoder, and prevPass1Cp is the first pass encoder estimated P complexity of the last P frame of the second pass encoder;
   where Rb represents the encoding bits of last B frame on the second pass encoder, Qb represents the average quantization level of last B frame on second pass encoder, Pass1Cb is the first pass encoder estimated B complexity of current B frame on the second pass encoder, and prevPass1Cb is the first pass encoder estimated B complexity of last B frame of the second pass encoder.

However, the initial bit budget cannot exceed the current available video buffering verifier (VBV_fullness), therefore, the final bit budget for I, P and B frame is:
I_final_bitbudget=min(I_bit_budget, VBV_fullness);
P_final_bitbudget=min(P_bit_budget, VBV_fullness);
B_final_bitbudget=min(B_bit_budget, VBV_fullness);

In other words, the final bit budget for each frame type cannot be greater than the current available space in the buffer. Thus, a min function is employed. Method 300 then ends in step 335. The method of FIG. 3 will allow a dual pass encoding system to properly adjust the bit budget of each picture in the image sequence before it is encoded into a compliant bitstream.

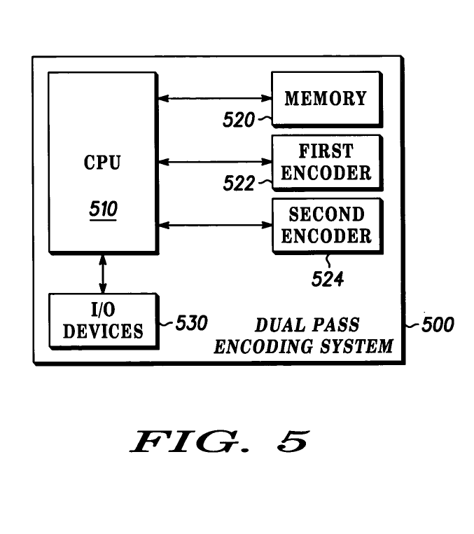

FIG. 4 illustrates a second method 400 for adjusting the bit budget of the present invention. Although it has been shown above that by knowing the complexity of a picture in advance, a rate control method can efficiently adjust the bit budget for each frame, there are situations where such adjustment can be further improved. Namely, the look ahead information may be needed for a number of pictures or frames to address events such as scene changes, new GOP starts and so on. These events often require encoding a picture as an I frame that often requires a large amount of encoding bits. If the detection of an upcoming I frame is detected too late, the complexity information received from the first encoder cannot be properly used. In other words, there simply are not enough coding bits to make the proper adjustment given that a potential I frame is rapidly approaching. To address this issue, it is beneficial to know in advance that a potential I frame is approaching so that the rate control method has sufficient time to make the adjustments now, e.g., spreading the adjustment over several frames. This scaling down operation will allow smoother transition to avoid drastic rate control scheme when the I frame arrives.

Method 400 starts in step 405 and proceeds to step 410. In step 410, method 400 retrieves complexity information or estimation from the first pass encoder and stores the information into a look up table.

In step 420, method 400 calculates the bit budget (bit_budget[0]) and VBV_fullness of the current frame. The method for calculating the bit budget can be in accordance with the method disclosed in FIG. 3 above.

In step 425, method 400 queries whether an upcoming frame will need to be encoded as an I frame. For example, the look up table may have the ability to store a plurality of frames, e.g., about 12 frames, where it is possible to see that one or more of the stored frames will need to be encoded as an I frame. It should be noted that the size of the lookup table is application specific and the present invention is not limited to a specific size. If the query is negatively answered, then method 400 proceeds to step 450, where the calculated bit budget is used in the encoding of the current frame. Method 400 then returns to step 410 to process the next frame. If the query is positively answered, them method 400 proceeds to step 430.

In step 430, method 400 retrieves the complexity information or estimation for the potential I frame from the look up table and computes the estimate bit budget, e.g., (I_bit_budget[k]). For example, if there is a potential I frame that is k=5 frames away from the current frame, then method 400 will immediately estimate the amount of bits that will be necessary to encode this I frame that is still 5 frames away. The distance of a potential I frame to a current frame before the present scaling operation is triggered is application specific, e.g., within 10 frames and so on.

In step 435, method 400 queries whether the estimate bit budget, e.g., (I_bit_budget[k]) for the potential I frame will exceed the available video buffering verifier (VBV_Fullness). If the query is negatively answered, then method 400 will proceed to step 450, where the current frame will be encoded using the calculated bit budget. In other words, no adjustment is made to the encoding of the current frame even though a pending I frame is approaching because there is sufficient space in the buffer.

However, if the query is positively answered, then method 400 will proceed to step 440, where the calculated bit budget for the current frame will be scaled down. In other words, method 400 detects that there is or may be insufficient space in the buffer so that it is necessary to adjust the bit budget of the current frame downward now even though the I frame may still be several frames away.

To illustrate, if the initial I bit budget is larger than the available VBV_fullness, a scaler would be calculated as follows. For example, the video frame sequence in the pipeline is f[i] where i=0, 1, 2, 3, . . . depending on the length of the look ahead pipeline. Let's suppose frame f(k) could be a possible I frame so far. Let's define the complexity of f[k] as Pass1Ci[k], Pass1Cp[k] and Pass1Cb[k], and calculate the bit budget of f[k] as I_bit_budget[k] as disclosed above in FIG. 3.
if (I_bit_budget [k]>VBV_fullness), then S=I_bit_budget [0]/VBV_fullness,
where S represents the scale factor once the I frame bit budget is larger than current VBV_fullness.

Then, the current frame's bit budget would be scaled down as following:
P_bit_budget [0]=P_bit_budget [0]/S;
P_final_bitbudget=min(P_bit_budget[0], VBV_fullness); if current frame is P frame;
or B_bit_budget [0]=B_bit_budget [0]/S;
B_final_bitbudget=min(B_bit_budget[0], VBV_fullness); if current frame is B frame.

Method 400 then proceeds to step 450, where the current frame is encoded using the newly scaled down bit budget. Method 400 then returned to step 410 where the next frame is processed. It should be noted that the next frame may or may not be scaled down. The main aspect is that one or more bit budgets of current frames can be scaled down in anticipation that the approaching I frame will be properly encoded.

FIG. 5 is a block diagram of the present dual pass encoding system being implemented with a general purpose computer. In one embodiment, the dual pass encoding system 500 is implemented using a general purpose computer or any other hardware equivalents. More specifically, the dual pass encoding system 500 comprises a processor (CPU) 510, a memory 520, e.g., random access memory (RAM) and/or read only memory (ROM), a first encoder 522, a second encoder 524, and various input/output devices 530 (e.g., storage devices, including but not limited to, a tape drive, a floppy drive, a hard disk drive or a compact disk drive, a receiver, a transmitter, a speaker, a display, an output port, a user input device (such as a keyboard, a keypad, a mouse, and the like), or a microphone for capturing speech commands).

It should be understood that the first encoder 522 and the second encoder 524 can be implemented as physical devices or subsystems that are coupled to the CPU 510 through a communication channel. Alternatively, the first encoder 522 and the second encoder 524 can be represented by one or more software applications (or even a combination of software and hardware, e.g., using application specific integrated circuits (ASIC)), where the software is loaded from a storage medium (e.g., a magnetic or optical drive or diskette) and operated by the CPU in the memory 520 of the computer. As such, the first encoder 522 and the second encoder 524 (including associated data structures) of the present invention can be stored on a computer readable medium or carrier, e.g., RAM memory, magnetic or optical drive or diskette and the like.

While the foregoing is directed to embodiments of the present invention, other and further embodiments of the invention may be devised without departing from the basic scope thereof, and the scope thereof is determined by the claims that follow.

1. A method for computing a bit budget for at least one picture in an image sequence, comprising:
encoding said at least one picture in a first encoder;
determining a complexity measure of said at least one picture from being encoded by said first encoder; and
computing a bit budget in accordance with said complexity measure for encoding said at least one picture in a second encoder.

2. The method of claim 1, wherein said second encoder is a compliant encoder in accordance with a compression standard.

3. The method of claim 2, wherein said compression standard is Moving Picture Experts Group (MPEG)-2.

4. The method of claim 1, wherein said computing step computes said bit budget based upon an encoding frame type selected for said at least one picture.

5. The method of claim 4, wherein said encoding frame type comprises at least one of I-frame, P-frame, and B-frame.

6. The method of claim 5, wherein said computing step computes said bit budget in accordance with:
for 1 frame: I_bit_budget=(bit_rate)/(Ki+(Kp*Cp/Ci)+(Kb*Cb/Ci));
for P frame: P_bit_budget=(bit_rate)/(Kp+(Ki*Ci/Cp)+(Kb*Cb/Cp));
for B frame: B_Bit_budget=(bit_rate)/(Kb+(Ki*Ci/Cb)+(Kp*Cp/Cb));
where Ki, Kp and Kb represent the number of I, P and B frames in a group of pictures (GOP); and
where Ci, Cp and Cb represent complexity coefficient of relative I, P and B frames.

7. The method of claim 6, wherein said Ci, Cp and Cb are expressed as:
Ci=Ri*Qi*Pass1Ci/prevPass1Ci;
Cp=Rp*Qp*Pass1Cp/prevPass1Cp;
Cb=Rb*Qb*Pass1Cb/prevPass1Cb;
where Ri represents encoding bits of a last I frame on said second encoder, Qi represents an average quantization level of said last I frame on said second encoder, Pass1Ci is a first encoder estimated I complexity of a current I frame on said second encoder, and prevPass1Ci is a first pass encoder estimated I complexity of last I frame of said second encoder;
where Rp represents encoding bits of a last P frame on said second encoder, Qp represents an average quantization level of said last P frame on said second encoder, Pass1Cp is a first pass encoder estimated P complexity of a current P frame on said second pass encoder, and prevPass1Cp is a first pass encoder estimated P complexity of said last P frame of said second encoder;
where Rb represents encoding bits of a last B frame on said second encoder, Qb represents an average quantization level of said last B frame on said second encoder, Pass1Cb is a first pass encoder estimated B complexity of a current B frame on said second encoder, and prevPass1Cb is a first pass encoder estimated B complexity of said last B frame of said second encoder.

8. The method of claim 5, wherein said computing step computes said bit budget in accordance with a fullness measure of a buffer.

9. The method of claim 8, wherein said computing step computes said bit budget in accordance with:
I_final_bitbudget=min(I_bit_budget, VBV_fullness);
P_final_bitbudget=min(P_bit_budget, VBV_fullness);
B_final_bitbudget=min(B_bit_budget, VBV_fullness); and
where VBV_fullness is said fullness measure.

10. The method of claim 1, further comprising:
storing a plurality of complexity measures of previously encoded pictures from said first encoder; and
scaling said bit budget of a current picture based upon one of said previously encoded pictures being a picture that needs to be encoded as an I-frame.

11. The method of claim 10, wherein said scaling step compares said bit budget with a fullness measure of a buffer to determine whether said scaling step is to be applied.

12. The method of claim 11, wherein said scaling is expressed as:
if (I_bit_budget [k]>VBV_fullness), then S=I_bit_budget [0]/VBV_fullness,
where S represents a scale factor, I_bit_budget [k] represents a bit budget for said picture that needs to be encoded as an I-frame, and VBV_fullness represents said fullness measure.

13. The method of claim 12, wherein said bit budget would be scaled down as follows:
P_bit_budget [0]=P_bit_budget [0]/S;
P_final_bitbudget=min(P_bit_budget[0], VBV_fullness); if said current picture is P frame;
or B_bit_budget [0]=B_bit budget [0]/S; and
B_final_bitbudget=min(B_bit_budget[0], VBV_fullness); if said current picture is B frame.

14. The method of claim 1, further comprising:
encoding said at least one picture into an encoded bit stream using said computed bit budget.

15. An apparatus for computing a bit budget for at least one picture in an image sequence, comprising:
a first encoder for encoding said at least one picture to generate a complexity measure of said at least one picture from being encoded by said first encoder; and
a second encoder for computing a bit budget in accordance with said complexity measure for encoding said at least one picture.

16. The apparatus of claim 15, wherein said second encoder computes said bit budget based upon an encoding frame type selected for said at least one picture, wherein said encoding frame type comprises at least one of I-frame, P-frame, and B-frame.

17. The apparatus of claim 16, wherein said bit budget is computed in accordance with:
for I frame: I_bit_budget=(bit_rate)/(Ki+(Kp*Cp/Ci)+(Kb*Cb/Ci));
for P frame: P_bit_budget=(bit_rate)/(Kp+(Ki*Ci/Cp)+(Kb*Cb/Cp));
for B frame: B_Bit_budget=(bit_rate)/(Kb+(Ki*Ci/Cb)+(Kp*Cp/Cb));
where Ki, Kp and Kb represent the number of I, P and B frames in a group of pictures (GOP); and
where Ci, Cp and Cb represent complexity coefficient of relative I, P and B frames.

18. The apparatus of claim 16, wherein said bit budget is computed in accordance with a fullness measure of a buffer.

19. The apparatus of claim 18, wherein said bit budget is computed in accordance with:
I_final_bitbudget=min(I_bit_budget, VBV_fullness);
P_final_bitbudget=min(P_bit_budget, VBV_fullness);
B_final bitbudget=min(B_bit_budget, VBV_fullness); and
where VBV_fullness is said fullness measure.

20. The apparatus of claim 15, further comprising:
a storage for storing a plurality of complexity measures of previously encoded pictures from said first encoder; and
wherein said second encoder scales said bit budget of a current picture based upon one of said previously encoded pictures being a picture that needs to be encoded as an I-frame.

21. The apparatus of claim 20, wherein said second encoder compares said bit budget with a fullness measure of a buffer to determine whether said scaling is to be applied.

22. The apparatus of claim 21, wherein said scaling is expressed as:
if (I_bit budget [k]>VBV_fullness), then S=I_bit_budget [0]/VBV_fullness,
where S represents a scale factor, I_bit_budget [k] represents a bit budget for said picture that needs to be encoded as an I-frame, and VBV_fullness represents said fullness measure.

23. The apparatus of claim 22, wherein said bit budget would be scaled down as follows:
P_bit_budget [0]=P_bit_budget [0]/S;
P_final_bitbudget=min(P_bit_budget[0], VBV_fullness); if said current picture is P frame;
or B_bit_budget [0]=B_bit_budget [0]/S; and
B_final_bitbudget=min(B_bit_budget[0], VBV_fullness); if said current picture is B frame.

24. A computer-readable carrier having stored thereon a plurality of instructions, the plurality of instructions including instructions which, when executed by a processor, cause the processor to perform the steps of a method for computing a bit budget for at least one picture in an image sequence, comprising of:
encoding said at least one picture in a first encoder;
determining a complexity measure of said at least one picture from being encoded by said first encoder; and
computing a bit budget in accordance with said complexity measure for encoding said at least one picture in a second encoder.

25. The computer-readable carrier of claim 24, wherein said second encoder is a Moving Picture Experts Group (MPEG)-2 compliant encoder.

26. The computer-readable carrier of claim 24, wherein said computing step computes said bit budget based upon an encoding frame type selected for said at least one picture, wherein said encoding frame type comprises at least one of I-frame, P-frame, and B-frame.

27. The computer-readable carrier of claim 26, wherein said computing step computes said bit budget in accordance with:
for I frame: I_bit_budget=(bit_rate)/(Ki+(Kp*Cp/Ci)+(Kb*Cb/Ci));
for P frame: P_bit_budget=(bit_rate)/(Kp+(Ki*Ci/Cp)+(Kb*Cb/Cp));
for B frame: B_Bit_budget=(bit_rate)/(Kb+(Ki*Ci/Cb)+(Kp*Cp/Cb));
where Ki, Kp and Kb represent the number of I, P and B frames in a group of pictures (GOP); and
where Ci, Cp and Cb represent complexity coefficient of relative I, P and B frames.

28. The computer-readable carrier of claim 27, wherein said Ci, Cp and Cb are expressed as:
Ci=Ri*Qi*Pass1Ci/prevPass1Ci;
Cp=Rp*Qp*Pass1Cp/prevPass1Cp;
Cb=Rb*Qb*Pass1Cb/prevPass1Cb;
where Ri represents encoding bits of a last I frame on said second encoder, Qi represents an average quantization level of said last I frame on said second encoder, Pass1Ci is a first encoder estimated I complexity of a current I frame on said second encoder, and prevPass1Ci is a first pass encoder estimated I complexity of last I frame of said second encoder;
where Rp represents encoding bits of a last P frame on said second encoder, Qp represents an average quantization level of said last P frame on said second encoder, Pass1Cp is a first pass encoder estimated P complexity of a current P frame on said second pass encoder, and prevPass1Cp is a first pass encoder estimated P complexity of said last P frame of said second encoder;
where Rb represents encoding bits of a last B frame on said second encoder, Qb represents an average quantization level of said last B frame on said second encoder, Pass1Cb is a first pass encoder estimated B complexity of a current B frame on said second encoder, and prevPass1Cb is a first pass encoder estimated B complexity of said last B frame of said second encoder.

29. The computer-readable carrier of claim 26, wherein said computing step computes said bit budget in accordance with a fullness measure of a buffer.

30. The computer-readable carrier of claim 29, wherein said computing step computes said bit budget in accordance with:
I_final_bitbudget=min(I_bit_budget, VBV_fullness);
P_final_bitbudget=min(P_bit_budget, VBV_fullness);
B_final_bitbudget=min(B_bit_budget, VBV_fullness); and
where VBV_fullness is said fullness measure.

31. The computer-readable carrier of claim 24, further comprising:
storing a plurality of complexity measures of previously encoded pictures from said first encoder; and
scaling said bit budget of a current picture based upon one of said previously encoded pictures being a picture that needs to be encoded as an I-frame.

32. The computer-readable carrier of claim 31, wherein said scaling step compares said bit budget with a fullness measure of a buffer to determine whether said scaling step is to be applied.

32. The computer-readable carrier of claim 32, wherein said scaling is expressed as:
if (I_bit_budget [k]>VBV_fullness), then S=I_bit_budget [0]/VBV_fullness,
where S represents a scale factor, I_bit_budget [k] represents a bit budget for said picture that needs to be encoded as an I-frame, and VBV_fullness represents said fullness measure.

33. The computer-readable carrier of claim 32, wherein said bit budget would be scaled down as follows:
P_bit_budget [0]=P_bit_budget [0]/S;
P_final_bitbudget=min(P_bit_budget[0], VBV_fullness); if said current picture is P frame;
or B_bit_budget [0]=B_bit_budget [0]/S; and
B_final_bitbudget=min(B_bit_budget[0], VBV_fullness); if said current picture is B frame.
